(19) United States
(12) Patent Application Publication
(10) Pub. No.: US 2019/0277268 A1
(43) Pub. Date: Sep. 12, 2019

(54) Thruster and Method for Producing Thrust Using a Plasma

(71) Applicants: The Boeing Company, Chicago, IL (US); The University of Washington, Seattle, WA (US)

(72) Inventors: Dejan Nikic, Seattle, WA (US); James A. Grossnickle, Bellevue, WA (US); Arthur C. Day, Chicago, IL (US); Uri Shumlak, Seattle, WA (US); Raymond Golingo, Seattle, WA (US)

(21) Appl. No.: 15/918,612

(22) Filed: Mar. 12, 2018

(51) Int. Cl. F03H 1/00; H05H 1/50; B64G 1/40

(52) U.S. Cl. CPC F03H 1/0081; B64G 1/406; B64G 1/405; H05H 1/50

(57) ABSTRACT

An example method for producing thrust includes injecting a neutral gas into a cavity between an outer electrode and an inner electrode of a thruster, ionizing the neutral gas within the cavity into a plasma, causing the plasma to form into a plasma arc between the end of the inner electrode and the exhaust orifice of the outer electrode, generating a magnetic field that applies pressure on the plasma arc, maintaining stability of the plasma arc, and exhausting the plasma arc out of the exhaust orifice based on the applied pressure of the magnetic field, thereby producing thrust.

### STATEMENT REGARDING FEDERALLY SPONSORED RESEARCH OR DEVELOPMENT

This invention was made with government support under Grant No. DE-FG02-04ER54756, awarded by the Department of Energy. The government has certain rights in the invention.

### FIELD

The present disclosure relates generally to operation of a spacecraft, and more particularly, to methods of

### BACKGROUND

Satellite missions can be accomplished with simple spacecraft, which may or may not include propulsive capability. Some satellites do not have any on-board thrust capability due to the fact that most thrusters require large energy sources or consume large amounts of fuel. With propulsive capability, however, a range of missions that can be accomplished with a given size of spacecraft can be greatly enhanced since the spacecraft is able to maneuver.

One type of propulsion includes chemical rocket propulsion, in which propellant is given thermal energy by a violent chemical reaction. By expanding exhaust gases through a nozzle, a temperature and pressure of the gases is reduced, and energy is converted into kinetic energy of a jet.

Another type of propulsion includes electric propulsion, in which a propellant's kinetic energy is derived from electrical energy. Many existing electric thruster, however, do not produce large amounts of thrust due to lack of an amount of propellant that can be “pushed” through the electric thruster.

What is needed is a thruster that has a high specific impulse, while providing high amount of thrust for desired movement.

### SUMMARY

In an example, a method for producing thrust is described. The method comprises injecting a neutral gas into a cavity between an outer electrode and an inner electrode of a thruster, and the outer electrode is positioned coaxially about the inner electrode and an end of the outer electrode includes an exhaust orifice. The inner electrode includes an end facing the exhaust orifice. The method also comprises ionizing the neutral gas within the cavity into a plasma, causing the plasma to form into a plasma arc between the end of the inner electrode and the exhaust orifice of the outer electrode, generating a magnetic field that applies pressure on the plasma arc, maintaining stability of the plasma arc, and exhausting the plasma arc out of the exhaust orifice based on the applied pressure of the magnetic field, thereby producing thrust.

In another example, a thruster is described that comprises an inner electrode including an end, and an outer electrode positioned coaxially about the inner electrode. An end of the outer electrode includes an exhaust orifice and the end of the inner electrode faces the exhaust orifice. The thruster also comprises a gas injection valve positioned on one of the outer electrode or the inner electrode enabling injection of a neutral gas into a cavity between the outer electrode and the inner electrode, and at least one power source coupled to the outer electrode and the inner electrode. The thruster also comprises a control device having a processor and memory storing instructions executable by the processor for operating the at least one power source to (i) cause voltage to be applied between the outer electrode and the inner electrode resulting in ionization of the neutral gas within the cavity into a plasma and causing the plasma to form into a plasma arc between the end of the inner electrode and the exhaust orifice of the outer electrode, and to (ii) generate a magnetic field that applies pressure on the plasma arc; operating the gas injection valve to inject the neutral gas into the cavity so as to envelope an outer surface of the plasma arc and to generate a continuous sheared-flow of plasma around the plasma arc to maintain stability of the plasma arc within the cavity; and operating the exhaust orifice to exhaust the plasma arc out of the exhaust orifice based on the applied pressure of the magnetic field, thereby producing thrust.

The features, functions, and advantages that have been discussed can be achieved independently in various examples or may be combined in yet other examples further details of which can be seen with reference to the following description and drawings.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying drawings, wherein:

FIG. 1 illustrates a block diagram of an example thruster, according to an example implementation.

FIG. 2 illustrates an example operation of the thruster as neutral gas is provided, according to an example implementation.

FIG. 3 illustrates an example operation of the thruster as the plasma continues to move further to the right until the plasma reaches the end of the inner electrode, according to an example implementation.

FIG. 4 illustrates an example operation of the thruster as the plasma continues to move further to the right and starts to fold onto itself, according to an example implementation.

FIG. 5 illustrates an example operation of the thruster as the current flowing through the plasma creates a stronger occurrence of the magnetic field within the cavity that squeezes or compresses portions of the plasma to form a plasma arc, according to an example implementation.

FIG. 6 illustrates an example operation of the thruster as for exhausting the plasma arc, according to an example implementation.

FIG. 7 illustrates a block diagram of another example of the thruster, according to an example implementation.

FIG. 8 illustrates an example graph of output thrust as a function of input current I using the thruster, according to an example implementation.

FIG. 9 shows a flowchart of an example method for producing thrust, according to an example implementation.

FIG. 10 shows a flowchart of an example method for performing the injecting as shown in FIG. 9, according to an example implementation.

FIG. 11 shows a flowchart of an example method for performing the ionizing as shown in FIG. 9, according to an example implementation.

FIG. 12 shows a flowchart of an example method for causing the plasma to form into the plasma arc, according to an example implementation.

FIG. 13 shows a flowchart of an example method for generating the magnetic field, according to an example implementation.

FIG. 14 shows a flowchart of another example method for generating the magnetic field, according to an example implementation.

FIG. 15 shows a flowchart of an example method for maintaining stability of the plasma arc, according to an example implementation.

FIG. 16 shows a flowchart of another example method for maintaining stability of the plasma arc, according to an example implementation.

FIG. 17 shows a flowchart of an example method for exhausting the plasma arc out of the exhaust orifice, according to an example implementation.

FIG. 18 shows a flowchart of an example method for use with the method shown in FIG. 9, according to an example implementation.

FIG. 19 shows a flowchart of an example method for use with the method shown in FIG. 9, according to an example implementation.

FIG. 20 shows a flowchart of an example method for use with the method shown in FIG. 9, according to an example implementation.

### DETAILED DESCRIPTION

Disclosed examples will now be described more fully hereinafter with reference to the accompanying drawings, in which some, but not all of the disclosed examples are shown. Indeed, several different examples may be described and should not be construed as limited to the examples set forth herein. Rather, these examples are described so that this disclosure will be thorough and complete and will fully convey the scope of the disclosure to those skilled in the art.

An arcjet rocket or arcjet thruster is a form of electrically powered spacecraft propulsion, in which an electrical discharge (arc) is created in a flow of propellant. An example arcjet uses a z-pinch, also known as zeta pinch, in which electrical current in plasma is used to generate a magnetic field that compresses the plasma (e.g., “pinches” it). The name refers to the direction of the current in the devices being along the z-axis as referred to in Cylindrical geometric coordinates (r, theta, z). The arcjet can be described as a z-pinch configuration in which walls are used to provide stabilization of the z-pinch. Such a configuration works because the walls are sufficiently close to the plasma to prevent magnetic instabilities that would otherwise disrupt the z-pinch and cause the thruster to cease operating.

However, while such arcjet configurations may operate well for some applications, it is limited in performance due to low temperature of the plasma. Since the walls used to stabilize the plasma are close to the plasma, the temperature is limited by the materials used for the walls. In some examples, tungsten is used for materials for the wall due to its high melting point. In those examples, arcjets operate at between 0.1N and 1N of thrust with specific impulse around 1000s. However, even with tungsten it may not be possible to generate high temperatures of the plasma necessary to increase efficiency and thrust of the device due to thermal losses of input power to the walls.

In one example, the temperature of the plasma can be increased by moving the walls further away. However, this would increase effects of magnetic instabilities and cause plasma disruptions.

Within examples described herein, sheared-flow of plasma is provided around the plasma arc to shed instabilities before they disrupt the plasma. The sheared-flow of plasma stabilizes the z-pinch thruster to produce large increases in thrust and specific impulse over traditional electric propulsion devices. The sheared-flow of plasma further allows the chamber walls to be farther away from plasma arc, thereby reducing thermal losses, which in turn allows the plasma arc to attain even higher temperatures. Higher operating temperatures result in higher thrust output, which can enable the electric engine to be more than just a tool for attitude adjustment, but also used for main engine thrust capabilities (e.g., enabling next generation space craft and long range/duration missions (i.e., rapid transfer to Mars)). Within examples, example thrusters described herein can reduce a Mars mission time from months to weeks, and LEO-GEO transfer time from months to days, compared to conventional thrusters.

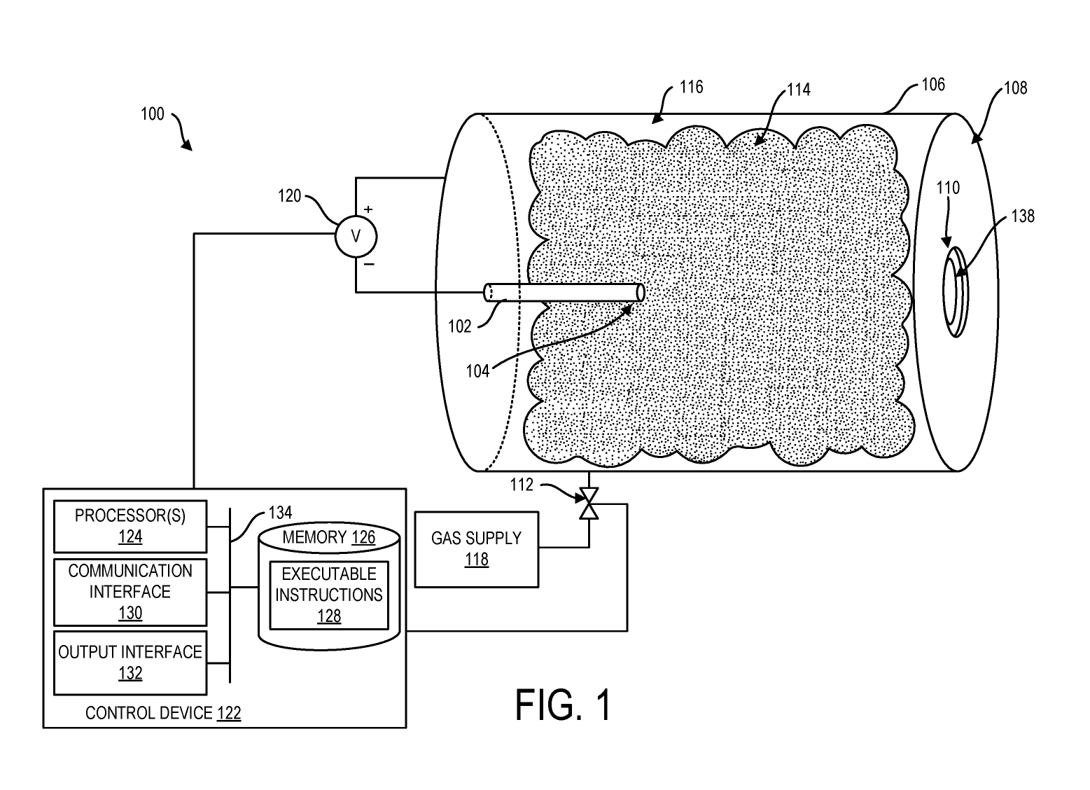

Referring now to the figures, FIG. 1 illustrates a block diagram of an example thruster 100, according to an example implementation. The thruster 100 includes an inner electrode 102 including an end 104, and an outer electrode 106 positioned coaxially about the inner electrode 102. The inner electrode 102 is shown to be located within an interior of the outer electrode 106. In some examples, the inner electrode 102 is a hollow cylinder. In other examples, the inner electrode 102 may include a nose cone on an end of the inner electrode 102. Alternatively or additionally, in some examples the outer electrode 106 is a hollow cylinder. The inner electrode 102 and the outer electrode 106 together may be considered a plasma confinement device.

In some examples, the inner electrode 102 is about 5 cm to about 15 cm in diameter, and the outer electrode 106 is placed coaxially around the inner electrode 102. The outer electrode 106 is about 10 cm to about 20 cm in diameter, for example. Within examples, the use of the term “about” herein refers to tolerances or variances of +/−5% of the measurement unit.

An end 108 of the outer electrode 106 includes an exhaust orifice 110 and the end 104 of the inner electrode 102 faces the exhaust orifice 110. The thruster 100 further includes a gas injection valve 112 positioned on one of the outer electrode 106 or the inner electrode 102 (shown in FIG. 1 positioned to be coupled to the outer electrode 106 ) enabling injection of a neutral gas 114 into a cavity 116 between the outer electrode 106 and the inner electrode 102. The gas injection valve 112 is coupled to a gas supply 118 that holds the neutral gas 114. The neutral gas 114 can include or be hydrogen, helium, methane, xenon, argon, or any type of noble gas, or other combinations of such gases as well. The neutral gas 114 is a non-fusable fuel for use in the thruster 100.

The thruster 100 also includes at least one power source 120 coupled to the outer electrode 106 and the inner electrode 102. The power source 120 may be configured to provide a range of voltages, and example power sources may be used that can provide voltages in a range of between about 500V to 10,000V, for example. In some examples, the power source 120 is capable of causing a current of between about 5,000 A to about 2,000,000 A to flow between the outer electrode 106 and the inner electrode 102. A size of the power source 120 and amount of voltage provided can depend upon a physical size of the thruster 100 and an amount of thrust desired.

The thruster 100 further includes a control device 122 having a processor 124 and memory 126, storing instructions 128 executable by the processor 124 for operating the thruster 100, as well as a communication interface 130 and an output interface 132 each connected to a communication bus 134. The control device 122 may also include hardware to enable communication within other computing devices (not shown). The hardware may include transmitters, receivers, and antennas, for example.

The communication interface 130 may be a wireless interface and/or one or more wireline interfaces that allow for both short-range communication and long-range communication to one or more networks or to one or more remote devices. Such wireless interfaces may provide for communication under one or more wireless communication protocols, Bluetooth, WiFi (e.g., an institute of electrical and electronic engineers (IEEE) 802.11 protocol), Long-Term Evolution (LTE), cellular communications, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network. Thus, the communication interface 130 may be configured to receive input data from one or more devices, and may also be configured to send output data to other devices.

The memory 126 may include data storage, such as one or more computer-readable storage media that can be read or accessed by the processor(s) 124. The computer-readable storage media can include volatile and/or non-volatile storage components, such as optical, magnetic, organic or other memory or disc storage, which can be integrated in whole or in part with the processor(s) 124. The memory 126 is considered non-transitory computer readable media. In some examples, the memory 126 can be implemented using a single physical device (e.g., one optical, magnetic, organic or other memory or disc storage unit), while in other examples, the memory 126 can be implemented using two or more physical devices. The memory 126 thus is a non-transitory computer readable storage medium, and executable instructions 128 are stored thereon. The executable instructions 128 include computer executable code.

The processor(s) 124 may be a general-purpose processor or special purpose processor (e.g., a digital signal processor, application specific integrated circuit, etc.). The processor(s) 124 may receive inputs from the communication interface 130, and process the inputs to generate outputs that are stored in the memory 126 and used to control operation of the thruster 100. The processor(s) 124 can be configured to execute the executable instructions 128 (e.g., computer-readable program instructions) that are stored in the memory 126 and are executable to provide the functionality of the control device 122 described herein.

The output interface 132 may be similar to the communication interface 130 and can be a wireless interface (e.g., transmitter) or a wired interface as well.

Within one example, in operation, when the executable instructions 128 are executed by the processor(s) 124 of the control device 122, the processor(s) 124 is caused to perform functions including to operate the at least one power source 120 to (i) cause voltage to be applied between the outer electrode 106 and the inner electrode 102 resulting in ionization of the neutral gas 114 within the cavity 116 into a plasma and causing the plasma to form into a plasma arc between the end of the inner electrode 102 and the exhaust orifice 110 of the outer electrode 106, and to (ii) generate a magnetic field that applies pressure on the plasma arc; operating the gas injection valve 112 to inject the neutral gas 114 into the cavity 116 causing a continuous sheared-flow of plasma to envelope an outer surface of the plasma arc to maintain stability of the plasma arc; and operating the exhaust orifice 110 to exhaust the plasma arc out of the exhaust orifice 110 based on the applied pressure of the magnetic field, thereby producing thrust.

In one example, the thruster includes a nozzle 138 that is positioned at the exhaust orifice 110. The nozzle 138 directs the plasma arc out of the exhaust orifice 110. In addition, different or additional nozzles may be included instead of or in addition to the nozzle 138 to exhaust the plasma arc out of the exhaust orifice 110 to produce thrust.

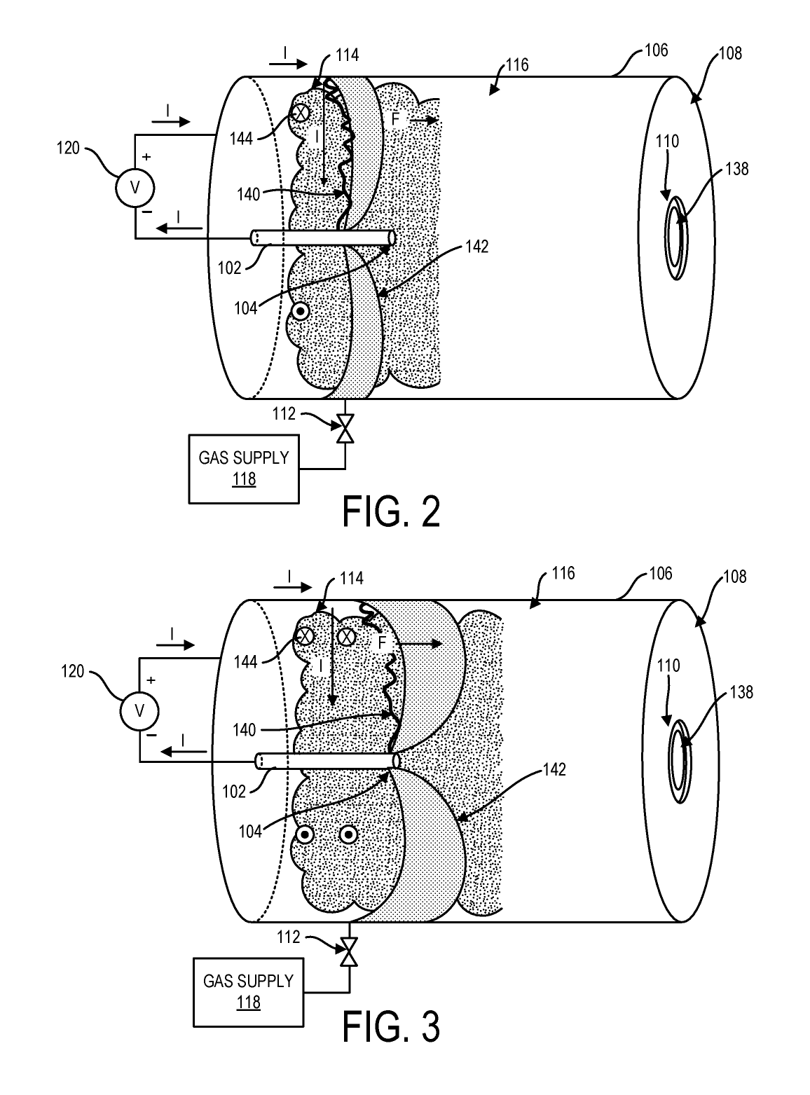

FIGS. 2-6 illustrate an example operation of the thruster 100, according to an example implementation. In FIGS. 2-6, the control device 122 is not shown for simplicity.

Referring to FIG. 2, during operation of the thruster 100, the neutral gas 114 is provided (e.g., injected or puffed) by the gas injection valve 112 into the cavity 116 between the inner electrode 102 and the outer electrode 106. The neutral gas 114 is pumped into the cavity 116 until a sufficiently high pressure is reached. An amount of pressure depends on an applied voltage and spacing between the inner electrode 102 and the outer electrode 106. As an example, a pressure threshold may be about a few mTorr or 10 mTorr.

Subsequent to or concurrent with providing the neutral gas 114 within the cavity 116, the power source 120 is activated, causing the power source 120 to apply a high voltage differential across the outer electrode 106 and the inner electrode 102. In response to application of the high voltage differential, an electric arc 140 forms between the outer electrode 106 and the inner electrode 102, causing the neutral gas 114 to ionize into a plasma 142 that is capable of conducting current. At this point, the plasma 142 is a low pressure/temperature plasma causing the current to flow between the inner electrode 102 and the outer electrode 106. The current flow pushes the plasma 142 to the right, due to the Lorentz forces (F).

In one example, about 5,000V are needed to initiate the electric arc 140 and cause the neutral gas 114 to ionize into the plasma 142. However, other voltage levels may be used as well depending upon an application and amount of thrust desired, such as between about 500V to 10,000V, for example.

Referring to FIG. 3, the low-pressure plasma 142 continues to move further to the right until the plasma 142 reaches the end 104 of the inner electrode 102. As shown in the Figures, the end 104 of the inner electrode 102 may be a hollow end, or may include a nose cone. However, other shapes and configurations of the inner electrode 102 may be used. Also shown in FIG. 3, the neutral gas 114 expands within the cavity 116 as well.

Current flowing through the plasma 142 (shown flowing from left to right in the figures) creates a magnetic field 144 within the cavity 116 that squeezes or compresses portions of the plasma 142. The magnetic field 144 increases a density of the plasma 142 causing an increase in pressure and temperature of the plasma 142.

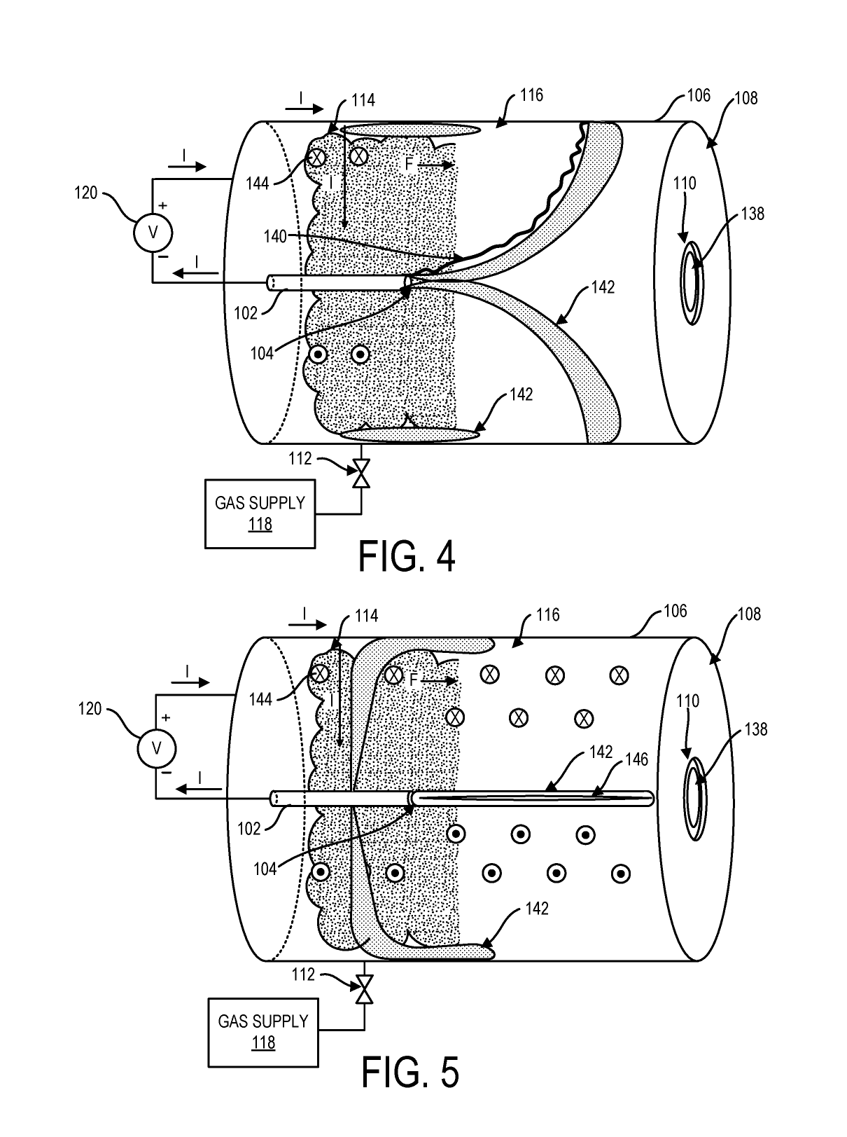

Referring to FIG. 4, the plasma 142 continues to move further to the right and starts to fold onto itself as the power source 120 continues to apply voltage. At this stage, the power source 120 may apply a lower voltage to continue to drive the thruster 100, such as about 1,000V. Additional plasma 142 forms on edges of the outer electrode 106. The continued application of the high voltage differential causes the current I to flow through the plasma 142 resulting in the plasma 142 continuing to move to the right.

Referring to FIG. 5, the current flowing through the plasma 142 creates a stronger occurrence of the magnetic field 144 within the cavity 116 that squeezes or compresses portions of the plasma 142 to form a plasma arc 146 between the end 104 of the inner electrode 102 and the exhaust orifice 110 of the outer electrode 106. The plasma arc 146 is now in a z-pinch configuration, and is self-reinforcing with the current flowing through the plasma 142 creating the magnetic field 144, and the magnetic field 144 in turn further compressing the plasma 142 formed from the neutral gas 114 in a region of the plasma arc 146. The cylindrical plasma 142 is directly driven by an axial current, and the self-generated magnetic field 144 compresses the plasma 142. Thus, the thruster 100 is configured to generate the plasma arc 146 using the neutral gas 114.

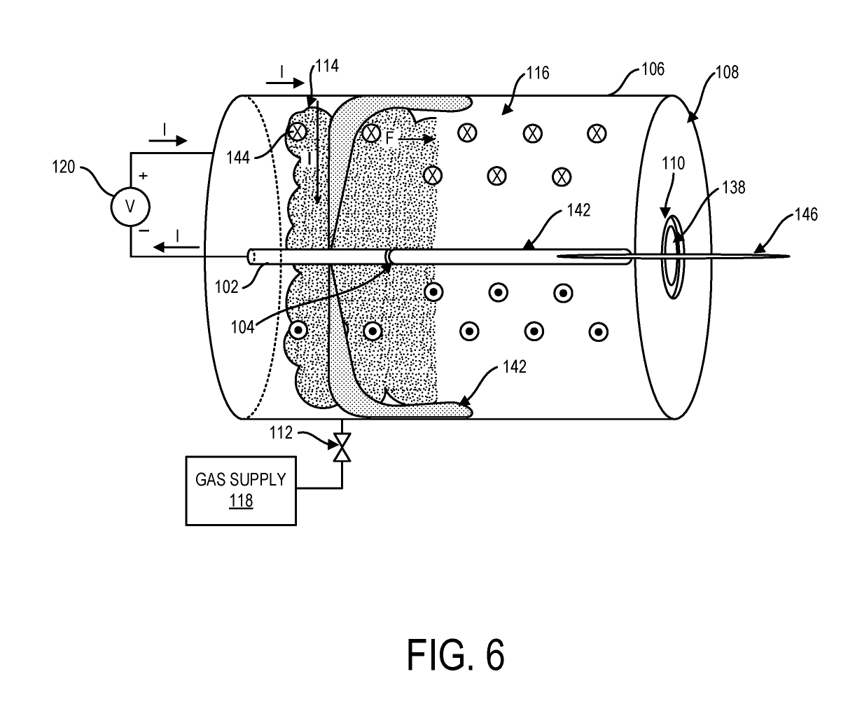

Referring to FIG. 6, at this point, the z-pinch configuration of the plasma arc 146 is fully formed and the plasma arc 146 is a high pressure/temperature plasma. The control device 122 then operates the exhaust orifice 110 to exhaust the plasma arc 146 out of the exhaust orifice 110 based on the applied pressure of the magnetic field, thereby producing thrust.

In some examples, the thruster 100 can be operated to provide the plasma arc 146 as a sheared-flow stabilized z-pinch. A sheared-flow stabilized z-pinch is a z-pinch that is stabilized by a flow (e.g., a continuous flow) of plasma outside (e.g., immediately outside of or proximate to) the plasma arc 146. In these examples, the control device 122 operates the gas injection valve 112 to inject the neutral gas 114 into the cavity 116 causing a continuous sheared-flow of plasma to envelope an outer surface of the plasma arc 146 to maintain stability of the plasma arc 146 (or at least increase a time of stability). Injection of the neutral gas 114 into the cavity 116 along with application of the voltage causes a flow of plasma proximate to the z-pinch configured plasma arc 146, and in some examples surrounding the plasma arc 146, inducing a sheared flow of the plasma 142 that stabilizes the z-pinch configured plasma arc 146 without using close fitting walls or axial magnetic fields, thereby enabling the z-pinch to remain stable.

The sheared-flow of the plasma 142 provided around the plasma arc 146 thereby stabilizes the plasma arc 146 enabling the plasma arc 146 to lengthen and be exhausted out of the exhaust orifice 110 without requiring a close proximity wall. For instance, the sheared-flow stabilization of the plasma arc 146 is used to maintain the outer electrode 106 walls distant from the plasma 142, which allows the plasma 142 to attain higher temperatures due to a decrease in thermal loss due to wall contact. The plasma 142 moves relative to the plasma arc 146 and conceptually operates as boundaries to confine and maintain a stability of the plasma arc 146.

It is desired to maintain stability of the plasma arc 146 in a substantially cylindrical form with no kinks or bends in the plasma arc 146 (e.g., a smooth outer surface). Without stability, as soon as ripples in an outer surface of the plasma arc 146 may form, instabilities cause the plasma arc 146 to break up resulting in a reduction or elimination of current flow and a reduction of possible thrust. Thus, using examples described herein enables the plasma arc 146 to be stabilized for extended periods of time, which enables thrust to be provided for longer periods of time. The stabilization of the plasma arc 146 further enables higher currents/voltages to be used, which in turn, enables generation of higher thrusts, for example.

In some examples, the flow of the plasma 142 has a sheared flow velocity profile in the sense that the plasma 142 flows at different velocity at an immediate edge of the plasma arc 146 than it does at radial distances farther from the plasma arc 146. For example, a velocity of the flow of plasma 142 over the plasma arc 146 increases based on a distance away from the plasma arc 146.

In some examples, the plasma arc 146 is stabilized during a duration of operation of the thruster 100. Thus, once at the stage of operation where the z-pinch configuration of the plasma arc 146 is formed, the plasma arc 146 will stay formed and be capable of producing thrust for as long as the sheared-flow of the plasma 142 is maintained (e.g., due to injection of the neutral gas 114 into the cavity 116 and power is continued to be applied by the power source 120 ).

Within the plasma arc 146 stabilized, a wall of the outer electrode 106 can be positioned further away from the plasma arc 146 enabling a temperature of the plasma arc 146 to be increased, resulting in higher output thrust capability. As an example, the wall of the outer electrode may be positioned a distance away from the plasma arc 146 of a distance equal to about ten times a diameter of the plasma arc 146. As an example, for a 1 cm diameter plasma arc, the wall of the outer electrode 106 may be about 10 cm away.

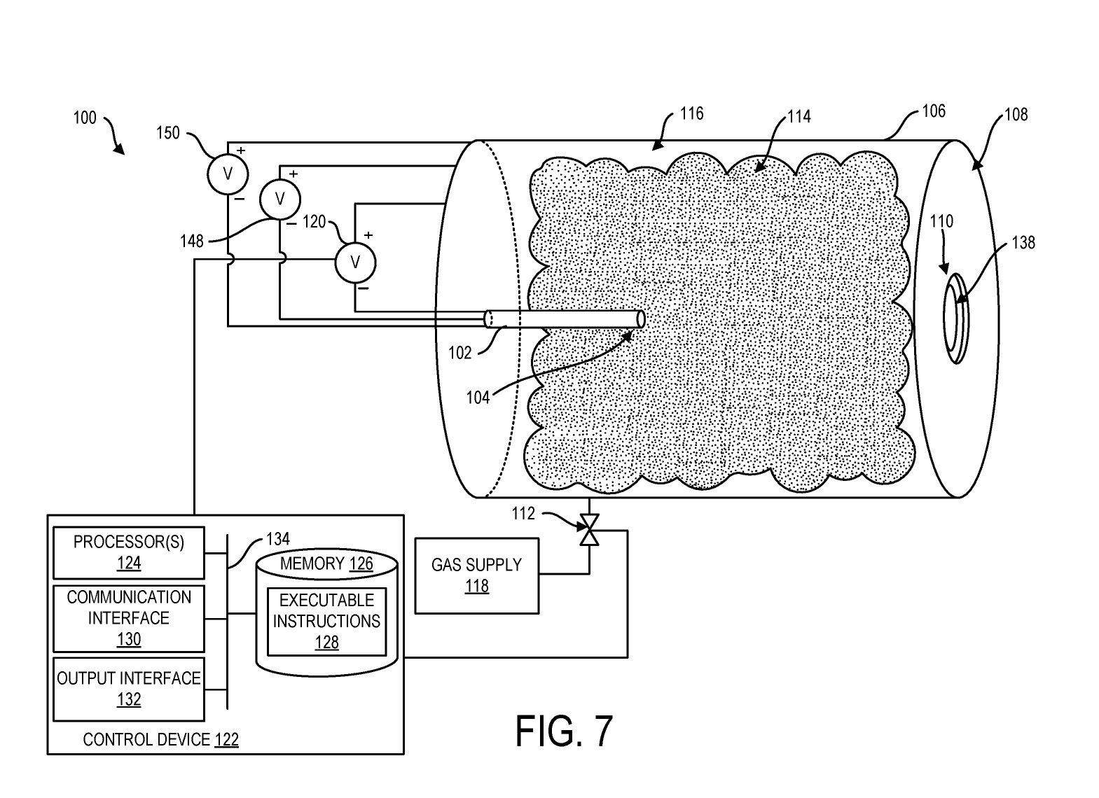

FIG. 7 illustrates a block diagram of another example of the thruster 100, according to an example implementation. In FIG. 7, the power source 120 for the thruster 100 is a first power source, and the thruster 100 includes a second power source 148 that is coupled to the outer electrode 106 and the inner electrode 102, and a third power source 150 that is coupled to the outer electrode 106 and the inner electrode 102. The first power source 120 may be operated to cause voltage to be applied between the outer electrode 106 and the inner electrode 102 for ionization of the neutral gas 114 within the cavity 116 into the plasma 142, the second power source 148 may be operated to cause the current I to flow between the outer electrode 106 and the inner electrode 102 that causes the plasma 142 to form into the plasma arc 146 between the end 104 of the inner electrode 102 and the exhaust orifice 110 of the outer electrode 106, and the third power source 150 may be operated to generate the magnetic field that applies pressure on the plasma arc 146 to exhaust the plasma arc 146 out of the exhaust orifice 110.

In other examples, the third power source 150 is not needed, and the second power source 148 can be operated to also generate the magnetic field that applies pressure on the plasma arc 146 to exhaust the plasma arc 146 out of the exhaust orifice 110.

In the example shown in FIG. 7, the ionization of the neutral gas 114 within the cavity 116 into the plasma 142 using the first power source 120 can be accomplished with a first voltage level and a first energy level, and the generation of the magnetic field that applies pressure on the plasma arc 146 using the second power source 148 can be accomplished with a second voltage level and a second energy level such that the first voltage level is higher than the second voltage level and the first energy level is lower than the second energy level. As such, the first power source 120 can be a high voltage and low energy power source to initiate the ionization and the second power source 148 can be a low voltage and high energy power source to drive the current needed to compress the plasma 142, for example. In this example, the formation of the plasma 142 within the cavity 116 is separated from compression of the plasma 142, for example.

An amount of thrust produced by the thruster 100 depends on a size of the thruster 100 as well as an applied voltage/current by the power source 120. In one example, the thruster 100 generates an output thrust that is proportional to a square of the current I flowing between the outer electrode 106 and the inner electrode 102. As an example, if 10,000 A are applied, the thruster 100 may generate about 2N. In further examples, the thruster 100 may be capable of generating an output thrust of up to about 100,000N with an application of 2MA.

Below is an example table of different operating parameters for the thruster 100 to provide various output thrusts. Generally, the input current determines other operating parameters.

Z-pinch operating parameters

| | | | | |
|---|---|---|---|---|
| Current [kA] | 20 | 40 | 60 | 200 |
| Thrust [N] | 10 | 40 | 90 | 1,000 |
| Power [kW] | 105 | 844 | 1,648 | 100,000 |
| Specific impulse | 9,170 | 18,350 | 27,520 | 90,000 |
| [s] | | | | |
| Thrust/power | 95 | 47 | 32 | 10 |
| [mN/kW] | | | | |

A thrust/power ratio of about ˜100 mN/kW is desirable for the thruster 100, for example, in some applications. As seen in the table, the operating parameters scale with the input current whereas the voltage and gas flow are specific parameters to a size and configuration of the thruster 100.

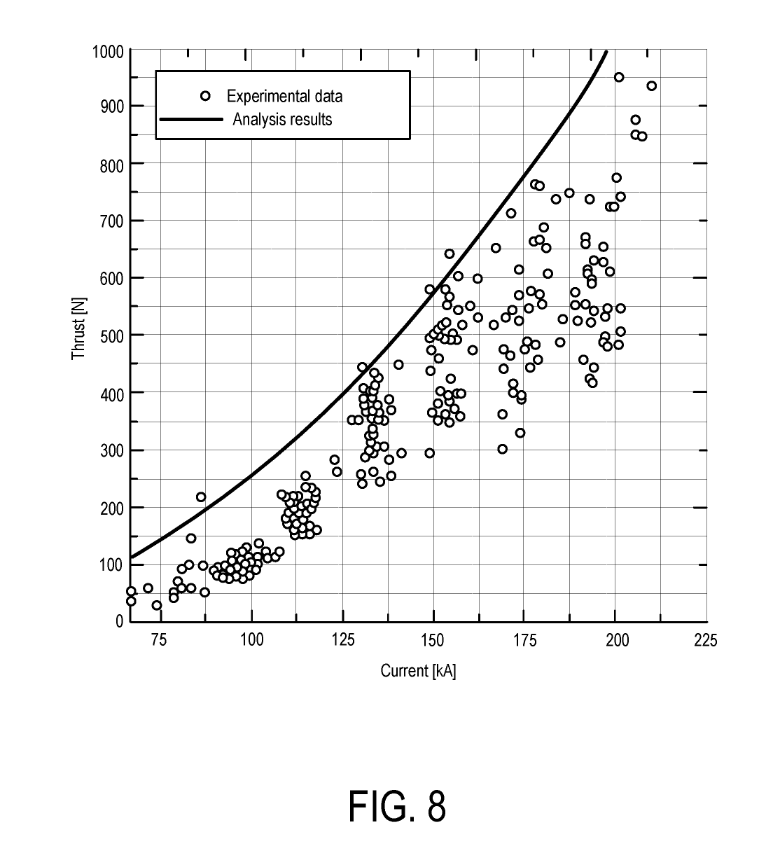

Example experiments were performed using the thruster 100 that showed that the thruster 100 can be stabilized on the 100 μs time scale (e.g., due to limit of the power supply used) with a 1 cm radius plasma arc with electrode walls 10 cm away from the plasma arc. With this configuration, it was possible to increase a temperature of plasma to about 250 eV (e.g., equivalent to more than 2.5 million degrees Kelvin). Based on these results, experiments were performed to measure a thrust out of the thruster 100, and results were favorable with peak thrust levels of up to about 1,000N. FIG. 8 illustrates an example graph of output thrust as a function of input current I using the thruster 100. As seen, output thrust levels reached about 1,000N for an input current I of about 200 kA.

In some examples, the thruster 100 can be operated at 100 μs and can be used in a pulsed mode for pulsed output thrusts. In a pulsed mode, a high voltage power source strikes up the electric arc 140 and the thruster 100 is operated for a threshold time and then shut off, and the process is repeated to generate pulsed thrusts.

In other examples, the thruster 100 can be operated in a continuous fashion or in a continuous mode for substantially continuous output thrust as long as the power and the sheared-flow of plasma is continuously provided. In a continuous mode, the electric arc 140 is created, and the thruster 100 then switches for use of a long duration power supply to provide a steady current along with a steady application of gas for the shear-flow. The thruster 100 will reach a steady-state operation to provide a substantially continuous amount of thrust. In addition, because the thruster 100 is stable, the continuous mode can be achieved, in contrast to unstable z-pinches that would only be able to provide very short pulses on the order of a few microseconds.

Within examples, substantially continuous thrust output means that thrust is provided on a continuous uninterrupted basis, or in instances in which an interruption may occur, the interruption is trivial or minor and does not adversely affect operation of the thruster 100, and the thruster 100 may be restarted for continuous operation.

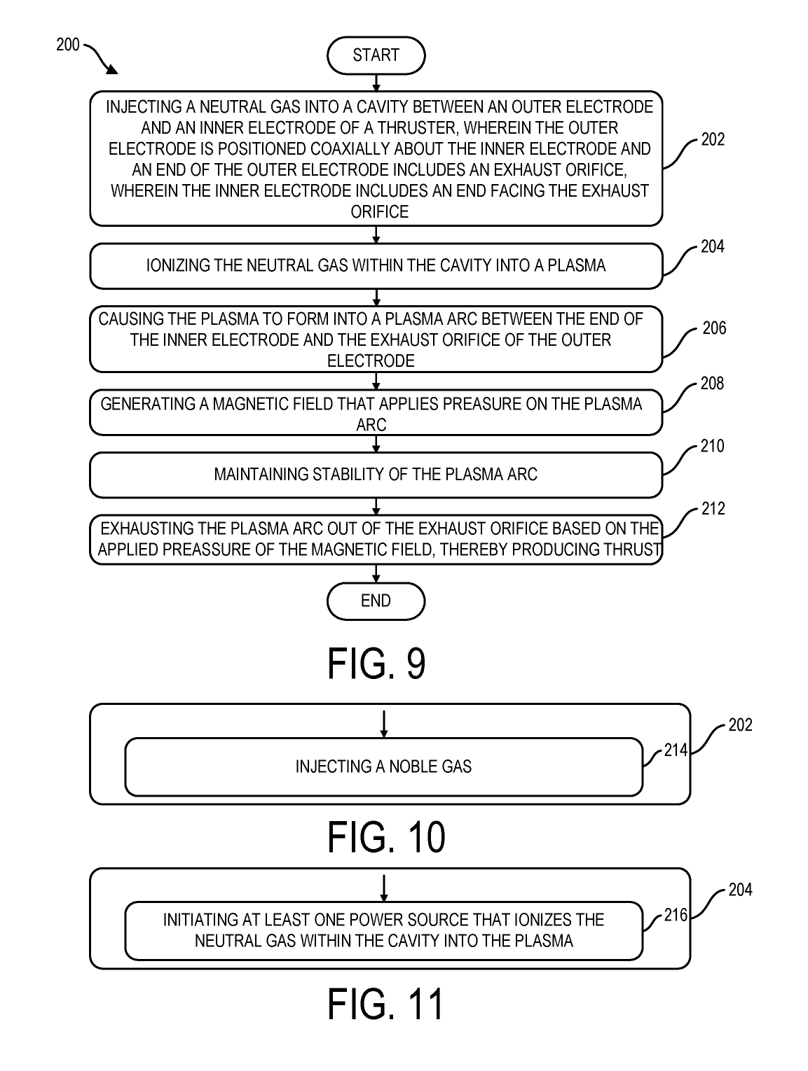

FIG. 9 shows a flowchart of an example method 200 for producing thrust, according to an example implementation. Method 200 shown in FIG. 9 presents an example of a method that could be used with the thruster 100 shown in FIGS. 1-7 or with components of the thruster 100, for example. Further, devices or systems may be used or configured to perform logical functions presented in FIG. 9. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner. Method 200 may include one or more operations, functions, or actions as illustrated by one or more of blocks 202-212. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

It should be understood that for this and other processes and methods disclosed herein, flowcharts show functionality and operation of one possible implementation of present examples. In this regard, some or all blocks (or portions of some or all blocks) may represent a module, a segment, or a portion of program code, which includes one or more instructions executable by a processor for implementing specific logical functions or steps in the process. The program code may be stored on any type of computer readable medium or data storage, for example, such as a storage device including a disk or hard drive. Further, the program code can be encoded on a computer-readable storage media in a machine-readable format, or on other non-transitory media or articles of manufacture. The computer readable medium may include non-transitory computer readable medium or memory, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a tangible computer readable storage medium, for example.

In addition, some or all blocks (or portions of some or all blocks) in FIG. 9, and within other processes and methods disclosed herein, may represent circuitry that is wired to perform the specific logical functions in the process. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 202, the method 200 includes injecting the neutral gas 114 into the cavity 116 between the outer electrode 106 and the inner electrode 102 of the thruster 100. The outer electrode 106 is positioned coaxially about the inner electrode 102 and the end 108 of the outer electrode includes the exhaust orifice 110, and the inner electrode 102 includes the end 104 facing the exhaust orifice 110.

FIG. 10 shows a flowchart of an example method for performing the injecting as shown in block 202, according to an example implementation. At block 214, functions include injecting a noble gas.

Referring back to FIG. 9, at block 204, the method 200 includes ionizing the neutral gas 114 within the cavity 116 into the plasma 142.

FIG. 11 shows a flowchart of an example method for performing the ionizing as shown in block 204, according to an example implementation. At block 216, functions include initiating at least one power source that ionizes the neutral gas 114 within the cavity 116 into the plasma 142.

Referring back to FIG. 9, at block 206, the method 200 includes causing the plasma 142 to form into the plasma arc 146 between the end 104 of the inner electrode 102 and the exhaust orifice 110 of the outer electrode 106.

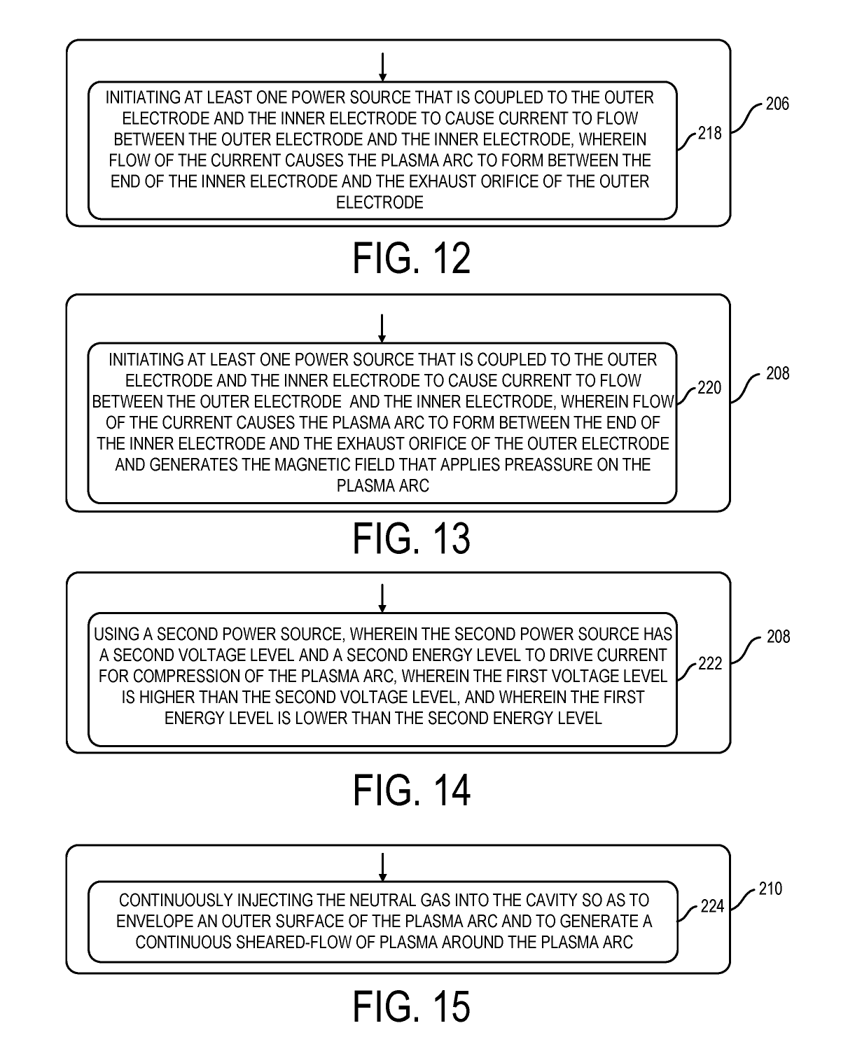

FIG. 12 shows a flowchart of an example method for causing the plasma 142 to form into the plasma arc 146, according to an example implementation. At block 218, functions include initiating at least one power source 120 that is coupled to the outer electrode 106 and the inner electrode 102 to cause current I to flow between the outer electrode 106 and the inner electrode 102, and wherein flow of the current I causes the plasma arc 146 to form between the end 104 of the inner electrode 102 and the exhaust orifice 110 of the outer electrode 106.

Referring back to FIG. 9, at block 208, the method 200 includes generating the magnetic field 144 that applies pressure on the plasma arc 146.

FIG. 13 shows a flowchart of an example method for generating the magnetic field 144, according to an example implementation. At block 220, functions include initiating at least one power source 120 that is coupled to the outer electrode 106 and the inner electrode 102 to cause current I to flow between the outer electrode 106 and the inner electrode 102, and flow of the current I causes the plasma arc 146 to form between the end 104 of the inner electrode 102 and the exhaust orifice 110 of the outer electrode 106 and generates the magnetic field 144 that applies pressure on the plasma arc 146.

FIG. 14 shows a flowchart of another example method for generating the magnetic field 144, according to an example implementation. At block 222, functions include ionizing the neutral gas 114 within the cavity 116 into the plasma 142 using a first power source 120 that has a first voltage level and a first energy level, and generating the magnetic field 144 using a second power source 148 that has a second voltage level and a second energy level to drive current for compression of the plasma arc 146. The first voltage level is higher than the second voltage level, and the first energy level is lower than the second energy level.

Referring back to FIG. 9, at block 210, the method 200 includes maintaining stability of the plasma arc 146.

FIG. 15 shows a flowchart of an example method for maintaining stability of the plasma arc 146, according to an example implementation. At block 224, functions include continuously injecting the neutral gas 114 into the cavity 116 so as to envelope an outer surface of the plasma arc 146 and to generate a continuous sheared-flow of plasma 142 around the plasma arc 146.

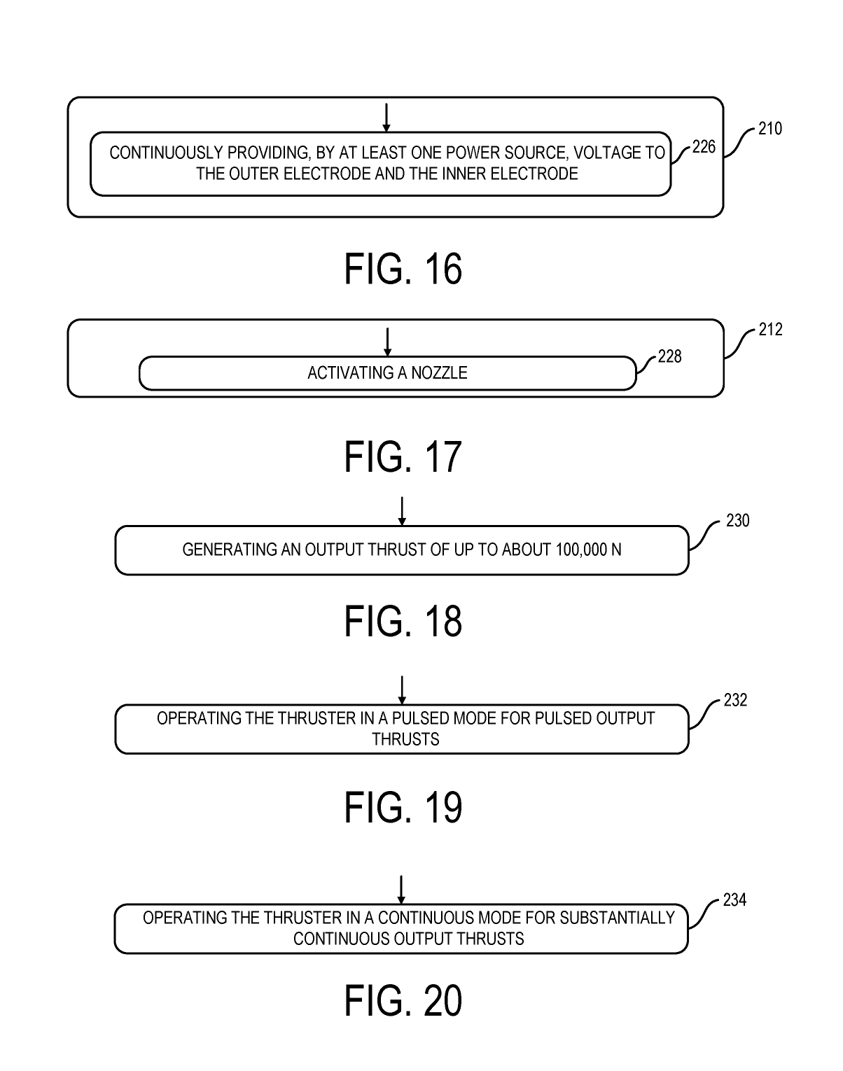

FIG. 16 shows a flowchart of another example method for maintaining stability of the plasma arc 146, according to an example implementation. At block 226, functions include continuously providing, by at least one power source, voltage to the outer electrode 106 and the inner electrode 102.

Referring back to FIG. 9, at block 212, the method 200 includes exhausting the plasma arc 146 out of the exhaust orifice 110 based on the applied pressure of the magnetic field 144, thereby producing thrust.

FIG. 17 shows a flowchart of an example method for exhausting the plasma arc 146 out of the exhaust orifice 110, according to an example implementation. At block 228, functions include activating a nozzle 138. For instance, the nozzle 138 may include an electromagnetic nozzle 138 that is activated by the control device 122, for example.

FIG. 18 shows a flowchart of an example method for use with the method 200, according to an example implementation. At block 230, functions include generating an output thrust of up to about 100,000 N.

FIG. 19 shows a flowchart of an example method for use with the method 200, according to an example implementation. At block 232, functions include operating the thruster in a pulsed mode for pulsed output thrusts.

FIG. 20 shows a flowchart of an example method for use with the method 200, according to an example implementation. At block 234, functions include operating the thruster in a continuous mode for substantially continuous output thrust.

By the term “substantially” and “about” used herein, it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

By the term “continuous” used herein, it is meant that the recited characteristic, parameter, or value need not be achieved exactly without interruption, but that instances of interruption may occur which are trivial or minor and do not adversely affect operation as intended.

Different examples of the system(s), device(s), and method(s) disclosed herein include a variety of components, features, and functionalities. It should be understood that the various examples of the system(s), device(s), and method(s) disclosed herein may include any of the components, features, and functionalities of any of the other examples of the system(s), device(s), and method(s) disclosed herein in any combination or any sub-combination, and all of such possibilities are intended to be within the scope of the disclosure.

The description of the different advantageous arrangements has been presented for purposes of illustration and description, and is not intended to be exhaustive or limited to the examples in the form disclosed. Many modifications and variations will be apparent to those of ordinary skill in the art. Further, different advantageous examples may describe different advantages as compared to other advantageous examples. The example or examples selected are chosen and described in order to best explain the principles of the examples, the practical application, and to enable others of ordinary skill in the art to understand the disclosure for various examples with various modifications as are suited to the particular use contemplated.

What is claimed is:

1. A method for producing thrust, the method comprising:
injecting a neutral gas into a cavity between an outer electrode and an inner electrode of a thruster, wherein the outer electrode is positioned coaxially about the inner electrode and an end of the outer electrode includes an exhaust orifice, wherein the inner electrode includes an end facing the exhaust orifice;
ionizing the neutral gas within the cavity into a plasma;
causing the plasma to form into a plasma arc between the end of the inner electrode and the exhaust orifice of the outer electrode;
generating a magnetic field that applies pressure on the plasma arc;
maintaining stability of the plasma arc; and
exhausting the plasma arc out of the exhaust orifice based on the applied pressure of the magnetic field, thereby producing thrust.

2. The method of claim 1, wherein injecting the neutral gas comprises injecting a noble gas.

3. The method of claim 1, wherein ionizing the neutral gas within the cavity into the plasma comprises:
initiating at least one power source that ionizes the neutral gas within the cavity into the plasma.

4. The method of claim 1, wherein causing the plasma to form into the plasma arc between the end of the inner electrode and the exhaust orifice of the outer electrode comprises:
initiating at least one power source that is coupled to the outer electrode and the inner electrode to cause current to flow between the outer electrode and the inner electrode, wherein flow of the current causes the plasma arc to form between the end of the inner electrode and the exhaust orifice of the outer electrode.

5. The method of claim 4, further comprising:
initiating the at least one power source to cause a current of between about 5,000 A to about 2,000,000 A to flow between the outer electrode and the inner electrode.

6. The method of claim 4, further comprising:
generating an output thrust that is proportional to a square of the current flowing between the outer electrode and the inner electrode.

7. The method of claim 1, wherein generating the magnetic field that applies pressure on the plasma arc comprises:
initiating at least one power source that is coupled to the outer electrode and the inner electrode to cause current to flow between the outer electrode and the inner electrode, wherein flow of the current causes the plasma arc to form between the end of the inner electrode and the exhaust orifice of the outer electrode and generates the magnetic field that applies pressure on the plasma arc.

8. The method of claim 1, wherein ionizing the neutral gas within the cavity into the plasma comprises using a first power source, wherein the first power source has a first voltage level and a first energy level,
wherein generating the magnetic field that applies pressure on the plasma arc comprises using a second power source, wherein the second power source has a second voltage level and a second energy level to drive current for compression of the plasma arc,
wherein the first voltage level is higher than the second voltage level, and
wherein the first energy level is lower than the second energy level.

9. The method of claim 1, wherein ionizing the neutral gas within the cavity into the plasma comprises initiating a first power source that is coupled to the outer electrode and the inner electrode to cause voltage to be applied between the outer electrode and the inner electrode,
wherein causing the plasma to form into the plasma arc between the end of the inner electrode and the exhaust orifice of the outer electrode comprises initiating a second power source that is coupled to the outer electrode and the inner electrode to cause current to flow between the outer electrode and the inner electrode, and
wherein generating the magnetic field that applies pressure on the plasma arc comprises initiating a third power source that is coupled to the outer electrode and the inner electrode.

10. The method of claim 1, wherein maintaining stability of the plasma arc comprises:
continuously injecting the neutral gas into the cavity so as to envelope an outer surface of the plasma arc and to generate a continuous sheared-flow of plasma around the plasma arc.

11. The method of claim 10, wherein maintaining stability of the plasma arc using the continuous sheared-flow of plasma around the plasma arc comprises:
continuously providing, by at least one power source, voltage to the outer electrode and the inner electrode.

12. The method of claim 10, wherein maintaining stability of the plasma arc using the continuous sheared-flow of plasma around the plasma arc comprises continuously injecting the neutral gas into the cavity such that a velocity of the flow of plasma over the plasma arc increases based on a distance away from the plasma arc.

13. The method of claim 1, wherein exhausting the plasma arc out of the exhaust orifice based on the applied pressure of the magnetic field, thereby producing thrust, comprises:
activating a nozzle.

14. The method of claim 1, further comprising:
generating an output thrust of up to about 100,000 N.

15. The method of claim 1, further comprising:
operating the thruster in a pulsed mode for pulsed output thrusts.

16. The method of claim 1, further comprising:
operating the thruster in a continuous mode for substantially continuous output thrust.

17. A thruster comprising:
an inner electrode including an end;
an outer electrode positioned coaxially about the inner electrode, wherein an end of the outer electrode includes an exhaust orifice and the end of the inner electrode faces the exhaust orifice;
a gas injection valve positioned on one of the outer electrode or the inner electrode enabling injection of a neutral gas into a cavity between the outer electrode and the inner electrode;
at least one power source coupled to the outer electrode and the inner electrode; and
a control device having a processor and memory storing instructions executable by the processor for:
operating the at least one power source to (i) cause voltage to be applied between the outer electrode and the inner electrode resulting in ionization of the neutral gas within the cavity into a plasma and causing the plasma to form into a plasma arc between the end of the inner electrode and the exhaust orifice of the outer electrode, and to (ii) generate a magnetic field that applies pressure on the plasma arc;
operating the gas injection valve to inject the neutral gas into the cavity so as to envelope an outer surface of the plasma arc and to generate a continuous sheared-flow of plasma around the plasma arc to maintain stability of the plasma arc within the cavity; and
operating the exhaust orifice to exhaust the plasma arc out of the exhaust orifice based on the applied pressure of the magnetic field, thereby producing thrust.

18. The thruster of claim 17, wherein the at least one power source coupled to the outer electrode and the inner electrode comprises:
a first power source that is coupled to the outer electrode and the inner electrode to cause voltage to be applied between the outer electrode and the inner electrode for ionization of the neutral gas within the cavity into the plasma;
a second power source that is coupled to the outer electrode and the inner electrode to cause current to flow between the outer electrode and the inner electrode that causes the plasma to form into the plasma arc between the end of the inner electrode and the exhaust orifice of the outer electrode; and
a third power source that is coupled to the outer electrode and the inner electrode generating the magnetic field that applies pressure on the plasma arc.

19. The thruster of claim 17, wherein the control device further:
operates the thruster in a pulsed mode for pulsed output thrusts.

20. The thruster of claim 17, wherein the control device further:
operates the thruster in a continuous mode for substantially continuous output thrust.
